(19) United States
(12) Patent Application Publication
(10) Pub. No.: US 2004/0268127 A1
(43) Pub. Date: Dec. 30, 2004

(54) Method and systems for securely exchanging data in an electronic transaction

(76) Inventor: Jagdeep Singh Sahota, Rodeo, CA (US)

Correspondence Address: Pepper Hamilton LLP, One Mellon Center, 50th Floor, 500 Grant Street, Pittsburgh, PA, 15219, US

(21) Appl. No.: 10/870,511

(22) Filed: Jun. 17, 2004

Related U.S. Application Data
(60) Provisional application No. 60/479,626, filed on Jun. 17, 2003.

(51) Int. Cl. H04L 9/00

(52) U.S. Cl. 713/175

(57) ABSTRACT

Methods and systems of encrypting and authenticating transaction data via the use of encryption and authentication algorithms are disclosed. Encryption and decryption algorithms are stored within a computer-readable storage medium and executed by a processor on a user device. These algorithms are used when a transaction is initiated by the user device with a point of transaction terminal across a communication interface to establish a secure connection for the transmission of data. Data relating to the transaction is then sent across the communication interface through the secure connection.

### RELATED APPLICATIONS AND CLAIM OF PRIORITY

This application claims priority to and incorporates by reference in its entirety, U.S. Provisional Application Ser. No. 60/479,626 entitled “Method for Securely Exchanging Data in an Electronic Transaction” filed Jun. 17, 2003.

### TECHNICAL FIELD

The present invention relates to methods of encrypting and securely exchanging data between electronic devices. More specifically, the present invention relates to methods of encrypting and securely exchanging data over a communication interface to complete a transaction or other exchange of electronically stored information.

### BACKGROUND

As the ease of electronically maintaining and exchanging information has continually increased, electronic data exchanges have become more prevalent. Today, Electronic Data Interchange (“EDI”) is well accepted in consumer, commercial, personal and other transactions. In particular, as the pace, quantity and breadth of EDI increases in commercial and personal settings, individuals or businesses are exchanging vast quantities of sensitive or proprietary data on a daily basis. Technological improvements have allowed businesses and individuals to engage in transactions in new and expanding environments. For example, payment of a transaction can now be made over a wireless interface such as in the case of a radio frequency enabled integrated circuit card or infrared enabled electronic devices.

As the use of EDI continues to expand, the need to securely exchange data has become critically important. Sensitive information, such as financial account information, payment information, passwords and other similar data may be exchanged in either commercial or consumer transactions.

The need to securely exchange data is not limited to financial and commercial transactions. For example, in a health care setting, the electronic storage and exchange of data comprising confidential patient information has become prevalent. In anticipation of the continued expansion of electronic storage of patient information into the health care field, the U.S. Health Insurance Portability and Accountability Act of 1996 requires the adoption and implementation of procedures to securely store and exchange all patient information which is in an electronic format.

Various methods of performing encryption and the secure exchange of data have been devised to provide increased security when electronically exchanging data between two electronic devices. Two of the more prevalent encryption methods used today are RSA encryption and triple-DES encryption.

RSA encryption is a public-key cryptosystem for both encryption and authentication that was first devised in 1977 by Ron Rivest, Adi Shamir, and Leonard Adleman. The RSA algorithm works as follows: take two large prime numbers, p and q, and find their product n=pq, n is called the modulus; choose an odd number, e, such that 1<e<n and e is relatively prime to (p−1)(q−1); compute the multiplicative inverse of e, called d, such that ed=1 (mod(p−1)(q−1)). It is well known that computing the multiplicative inverse of e entails finding an integer, x, such that d=(x(p−1)(q−1)+1)/e is also an integer. e and d are called the public and private exponents, respectively. The public key is the pair (n, e) and the private key is d. The factors p and q must be kept secret. It is difficult (presumably) to obtain the private key d from the public key (n, e). If one could factor n into p and q, however, then one could obtain the private key d. As such, the entire security of RSA depends on the difficulty of factoring.

Triple-DES is a private-key encryption method, which is based on an earlier private-key encryption method known as DES. In Triple-DES encryption, the input data is, in effect, encrypted three times using the DES method. There are a variety of ways of doing this; the ANSI X9.52 standard defines triple-DES encryption with keys k1, k2, k3 as C=Ek3(Dk2(Ek1(M))), where Ek and Dk denote DES encryption and DES decryption, respectively, with the key k, M is the message to be encrypted, and C is the encrypted message. This mode of encryption is sometimes referred to as DES-EDE. Another variant is DES-EEE, which consists of three consecutive encryptions. Three keying options are defined in ANSI X9.52 for DES-EDE: 1) the three keys k1, k2 and k3 are independent; 2) k1 and k2 are independent, but k1=k3; and 3) k1=k2=k3. The third option makes triple-DES backward compatible with DES.

The effectiveness of known encryption techniques is a matter of great concern in the financial transactions industry as financial services are being delivered in novel ways such as through wireless interfaces. Use of traditional encryption techniques have subjected these transactions to potential security breaches, such as what is known as the “man in the middle” attack.

Accordingly, what is needed is a method and system for securely exchanging data which can be useful in financial transactions in order to prevent data theft and subsequent fraud.

A further need exists for a method and system of securely exchanging data which can be useful in credit card transactions in order to prevent credit theft and subsequent credit card fraud using, for example, smart card technology.

It will be appreciated that the methods and techniques of the present invention will be equally effective in non-financial environments.

### SUMMARY

It is an object of the present invention to create a secure channel for the exchange of data between two electronic devices by creating a shared secret key through the use and exchange of public key data.

In an embodiment, a method of ensuring secure data exchange includes initiating a transaction from a user device, transmitting, via a communication interface, one or more public key certificates from the user device to a point of transaction terminal, performing one or more encryption algorithms using the one or more public key certificates and one or more keys to produce an encrypted data block at the point of transaction terminal, transmitting, via the communication interface, the encrypted data block from the point of transaction terminal to the user device, performing a decryption algorithm on the encrypted data block using a device private key to decrypt a random session key on the user device, performing an encryption algorithm using transaction data and the random session key to produce encrypted transaction data on the user device, transmitting, via the communication interface, the encrypted transaction data from the user device to the point of transaction terminal, and performing a decryption algorithm on the encrypted transaction data to decrypt the transaction data at the point of transaction terminal. The user device may include a storage medium for storing the one or more public key certificates and the device private key, and a processing module for performing encryption and decryption algorithms. The one or more public key certificates may include a service provider public key certificate and a device public key certificate. In an embodiment, performing one or more encryption algorithms includes performing an encryption algorithm using a service provider public key certificate and a service provider certificate authority public key to produce a service provider public key, performing an encryption algorithm using a device public key certificate and the service provider public key to produce a device public key, generating a session key, and performing an encryption algorithm using the session key and the device public key to produce an encrypted data block.

In an embodiment, a user device for ensuring secure data exchange includes a processor, a communication interface operably connected to the processor, and a computer-readable storage medium operably connected to the processor. The computer-readable storage medium contains one or more programming instructions for performing a method for ensuring secure data exchange including transmitting, via the communication interface, one or more public key certificates, receiving, via the communication interface, an encrypted data block, performing a decryption algorithm on the encrypted data block using a device private key to decrypt a random session key, performing an encryption algorithm using transaction data and the random session key to produce encrypted transaction data, and transmitting, via the communication interface, the encrypted transaction data. The one or more public key certificates may include a service provider public key certificate and a device public key certificate.

In an embodiment, a point of transaction terminal for ensuring secure data exchange includes a processor, a communication interface operably connected to the processor, and a computer-readable storage medium operably connected to the processor. The computer-readable storage medium contains one or more programming instructions for performing a method for ensuring secure data exchange including receiving, via the communication interface, one or more public key certificates, performing one or more encryption algorithms using the one or more public key certificates and one or more keys to produce an encrypted data block, transmitting, via the communication interface, the encrypted data block, receiving, via the communication interface, encrypted transaction data from, and performing a decryption algorithm on the encrypted transaction data to decrypt the transaction data. The one or more public key certificates may include a service provider public key certificate and a device public key certificate. In an embodiment, performing one or more encryption algorithms includes performing an encryption algorithm using the service provider public key certificate and a service provider certificate authority public key to produce a service provider public key at the point of transaction terminal, performing an encryption algorithm using the device public key certificate and the service provider public key to produce a device public key at the point of transaction terminal, generating a session key at the point of transaction terminal, and performing an encryption algorithm using the session key and the device public key to produce an encrypted data block at the point of transaction terminal.

Various aspects and applications of the present invention will become apparent to the skilled artisan upon consideration of the brief description of the figures and the detailed description of the invention which follows.

### BRIEF DESCRIPTION OF THE DRAWINGS

Aspects, features, benefits and advantages of the embodiments of the present invention will be apparent with regard to the following description, appended claims and accompanying drawings where:

FIG. 1 is a depiction of an exemplary embodiment for generating a service provider public key.

FIG. 2 is a depiction of an exemplary embodiment for generating the device public key.

FIG. 3 is a depiction of an exemplary embodiment of encrypting a session key to generate an encrypted data block.

FIG. 4 is a depiction of an exemplary embodiment of transmitting the encrypted data block over a communication interface.

FIG. 5 is a depiction of an exemplary embodiment of decrypting a random session key from the encrypted data block.

FIG. 6 is a depiction of an exemplary embodiment of encrypting transaction data using a random session key for transmission over a communication interface.

FIG. 7 is a diagram of the interaction of the various techniques utilized to establish secure channel for the exchange of data.

### DETAILED DESCRIPTION

Before the present methods and systems are described, it is to be understood that this invention is not limited to the particular methodologies, systems or protocols described, as these may vary. It is also to be understood that the terminology used in the description is for the purpose of describing the particular versions or embodiments only, and is not intended to limit the scope of the present invention which will be limited only by the appended claims. In particular, although the present invention is described in conjunction with a financial transaction, it will be appreciated that the present invention may find use in any electronic exchange of data.

It must also be noted that as used herein and in the appended claims, the singular forms “a”, “an”, and “the” include plural reference unless the context clearly dictates otherwise. Thus, for example, reference to a “key” is a reference to one or more keys and equivalents thereof known to those skilled in the art, and so forth. Unless defined otherwise, all technical and scientific terms used herein have the same meanings as commonly understood by one of ordinary skill in the art. Although any methods and devices similar or equivalent to those described herein can be used in the practice or testing of embodiments of the present invention, the preferred methods and devices are now described. All publications mentioned herein are incorporated by reference. Nothing herein is to be construed as an admission that the invention is not entitled to antedate such disclosure by virtue of prior invention.

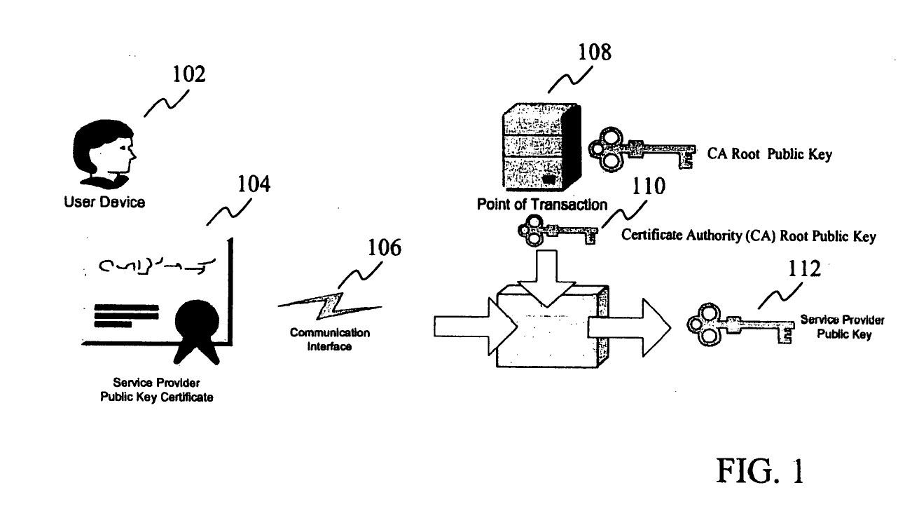

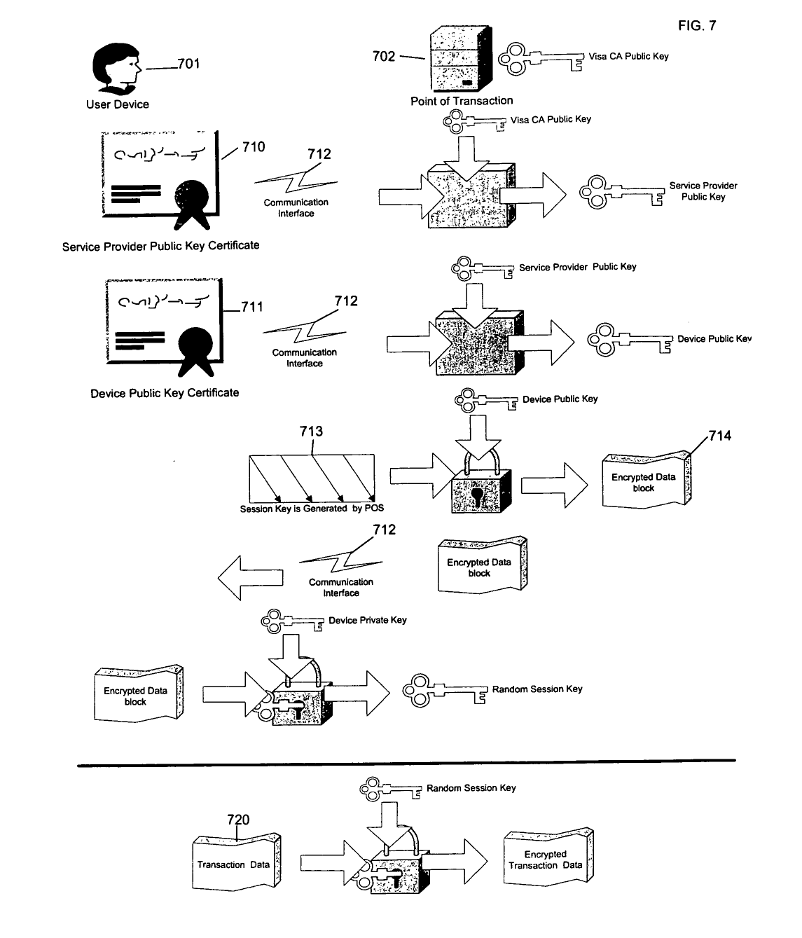

As shown in FIG. 7, the present invention generally comprises a first device, also referred to herein as a user device 701, and a second device, also referred to herein as a point of transaction terminal 702. As discussed more fully in conjunction with FIGS. 1-6, the first device 701 transmits a service provider public key certificate 710 and a device public key certificate 711 over a communications interface 712 to the second device 702. The service provider public certificate 710 and the device public key certificate 711 may be transmitted to the second device 702 separately or simultaneously. The second device 702 then generates a session key 713 which is encrypted utilizing the certificates received from the first device 701. The encrypted session key 714 is transmitted to the first device 701 over the communications interface 712. The first device 701 decrypts the encrypted session key 714. The session key then constitutes a shared secret between the first device 701 and the second device 702 which is utilized to encrypt and securely exchange subsequent transaction data 720.

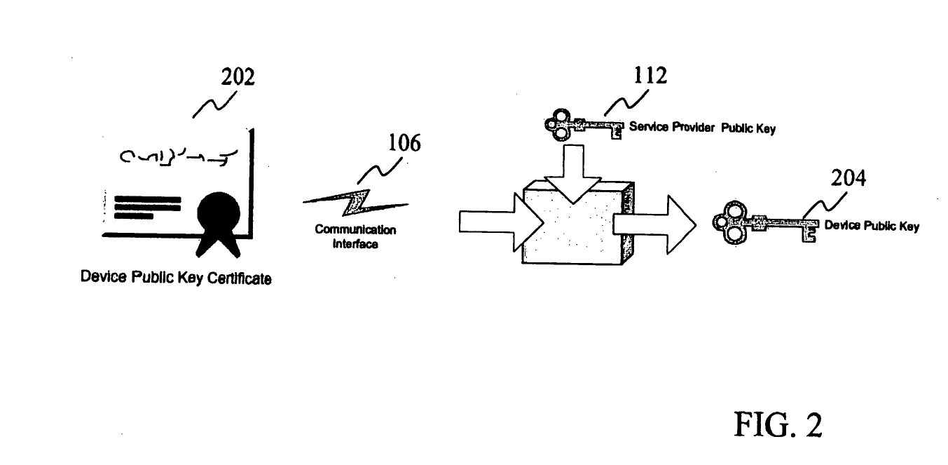

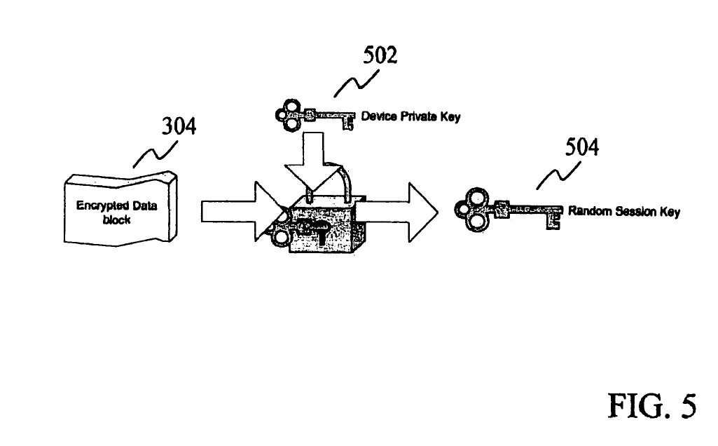

The specific steps of the present invention will now be discussed in detail. Deriving a service provider public key is depicted in FIG. 1. A first device, also referred to as a user device 102, may include, without limitation, a contactless card, an integrated chip card, a radio frequency identification device, an electronic device with payment services deployed thereon, a computer or any similar device or card capable of interfacing with a second device 108. The user device 102 may include, for example, a processor a communication interface, and a computer-readable storage medium that contains a service provider public key certificate 104 assigned by the service provider. The computer-readable storage medium of the user device 102 may further contain a device public key certificate 202, depicted in FIG. 2, and a device private key 502, depicted in FIG. 5. The service provider public key certificate 104 and the device public key certificate 202 may be securely stored on the user device 102 and may be used, alone or in combination, to create a secure channel for exchanging transaction data between the user device 102 and a point of transaction terminal 108. The device private key 502 may be used to transmit data through the secure channel created with the aid of one or more of the service provider public key certificate 104 and the device public key certificate 202.

The point of transaction terminal 108 may be a point of sale terminal, credit authorization terminal or any other electronic device and may have a certificate authority (CA) root public key 110. The point of transaction terminal 108 may include a processor, a communication interface and a computer-readable storage medium. The user device 102 may send the service provider public key certificate 104 over the communication interface 106 to the point of transaction terminal 108. The communication interface 106 may include, without limitation, a telephone network, a telecommunications network, such as the Internet, an intranet, or an extranet, any wireless communication method, and/or any combination of the foregoing. The service provider public key certificate 104 may be signed by the service provider root private key. In an embodiment, standard RSA encryption algorithms may be used to generate the service provider public key 112 in the point of transaction terminal 108 from the CA root public key 110 and the service provider public key certificate 104. In an alternate embodiment, other encryption algorithms may be used to generate the service provider public key 112.

An exemplary method of generating a device public key is depicted in FIG. 2. The device public key certificate 202 may be sent over the communication interface 106. Standard RSA encryption algorithms may be used to generate the device public key 204 from the service provider public key 112 and the device public key certificate 202. In an alternate embodiment, other encryption algorithms may be used to generate the device public key 204. The transmission of the device public key 204 and the generation of the service provider public key 112 may be performed as part of a single data exchange or separately.

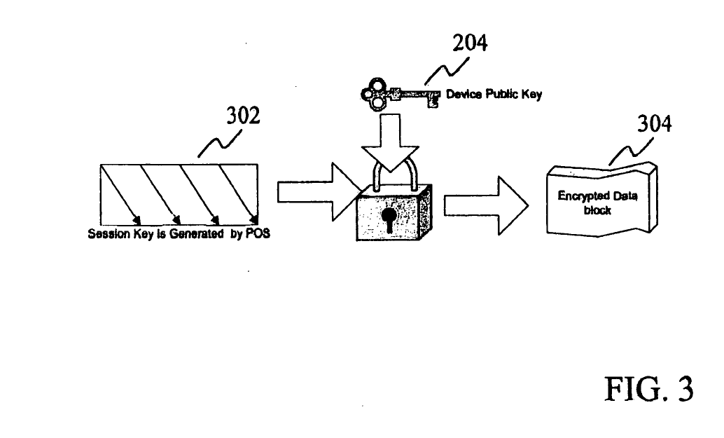

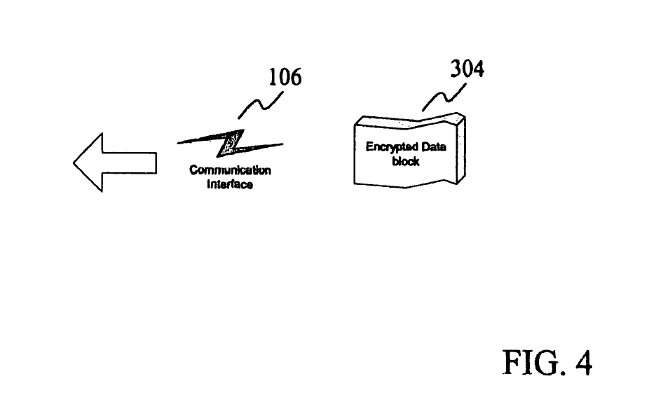

Encrypting a session key to generate an encrypted data block is depicted in FIG. 3. A session key 302 may be generated by the point of transaction terminal 108 through a random generation sequence. The session key 302 may be of any size. In an embodiment, the session key 302 is 16 bytes in length. In an embodiment, standard RSA encryption algorithms may be used to generate an encrypted data block 304 from the session key 302 and the device public key 204. In an alternate embodiment, other encryption algorithms may be used to generate the encrypted data block 304. The encrypted data block 304 may then be transmitted over the communication interface 106 to the user device 102 as depicted in FIG. 4.

Decrypting a random session key from the encrypted data block is depicted in FIG. 5. The device private key 502 contained in the user device 102 may be used to decrypt the encrypted data block 304 that was received from the point of transaction terminal 108. In an embodiment, the decryption may be performed using RSA decryption algorithms or any other decryption algorithm that would authenticate the encryption used to encrypt the data in the encrypted data block 304. The user device 102 may extract a random session key 504 from the encrypted data block 304 using the device private key 502. Through this method, the user device 102 and the point of transaction terminal 108 have encryption keys that may be used to decrypt information from each other. Specifically, the point of transaction terminal 108 may use the session key 302 to decrypt information transmitted from the user terminal 102 that is encrypted using the random session key 504.

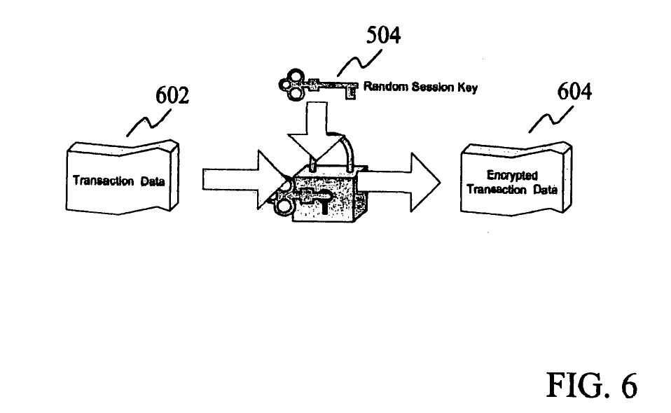

Encrypting transaction data using a random session key for transmission over a communication interface is depicted in FIG. 6. Transaction data 602, such as payment information in a credit card exchange, at the user terminal 102 may be encrypted by an encryption algorithm using the random session key 504. In an embodiment, the encryption algorithm may be triple-DES. The encrypted transaction data block 604 may then be transmitted over the communication interface 106 to the point of transaction terminal 108. The point of transaction terminal 108 may use the session key 304 to decrypt the encrypted transaction data block 604 to extract payment information input at the input device 102.

It is to be understood that the invention is not limited in its application to the details of construction and to the arrangements of the components set forth in this description or illustrated in the drawings. The invention is capable of other embodiments and of being practiced and carried out in various ways. Hence, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the description be regarded as including such equivalent constructions insofar as they do not depart from the spirit and scope of the present invention.

What is claimed is:

1. A method of ensuring secure data exchange, comprising:
transmitting, via a communication interface, one or more public key certificates from a user device to a point of transaction terminal;
performing one or more first encryption algorithms using the one or more public key certificates and one or more keys to produce an encrypted data block at the point of transaction terminal;
transmitting, via the communication interface, the encrypted data block from the point of transaction terminal to the user device;
performing a first decryption algorithm on the encrypted data block using a device private key to decrypt a random session key on the user device;
performing a second encryption algorithm using transaction data and the random session key to produce encrypted transaction data on the user device;
transmitting, via the communication interface, the encrypted transaction data from the user device to the point of transaction terminal; and
performing a second decryption algorithm on the encrypted transaction data to decrypt the transaction data at the point of transaction terminal.

2. The method of claim 1, further comprising:
initiating a transaction from the user device.

3. The method of claim 1, further comprising:
initiating a transaction from the point of transaction terminal;

4. The method of claim 1 wherein the user device comprises:
a storage medium for storing the one or more public key certificates and the device private key; and
a processing module for performing encryption and decryption algorithms.

5. The method of claim 1 wherein the one or more public key certificates comprise:
a service provider public key certificate; and
a device public key certificate.

6. The method of claim 1 wherein performing one or more encryption algorithms comprises:
performing an encryption algorithm using the service provider public key certificate and a service provider certificate authority public key to produce a service provider public key;
performing an encryption algorithm using the device public key certificate and the service provider public key to produce a device public key;
generating a session key; and
performing an encryption algorithm using the session key and the device public key to produce an encrypted data block.

7. The method of claim 1 wherein each of the first encryption algorithms and the second encryption algorithm comprises one or more of the following:
an RSA encryption algorithm;
a DES encryption algorithm; and
a Triple-DES encryption algorithm.

8. The method of claim 1 wherein each of the first decryption algorithm and the second decryption algorithm comprises one or more of the following:
an RSA decryption algorithm;
a DES decryption algorithm; and
a Triple-DES decryption algorithm.

9. A user device for ensuring secure data exchange, comprising:
a processor;
a communication interface operably connected to the processor; and
a computer-readable storage medium operably connected to the processor,
wherein the computer-readable storage medium contains one or more programming instructions for performing a method for ensuring secure data exchange, the method comprising:
transmitting, via the communication interface, one or more public key certificates,
receiving, via the communication interface, an encrypted data block,
performing a decryption algorithm on the encrypted data block using a device private key to decrypt a random session key,
performing an encryption algorithm using transaction data and the random session key to produce encrypted transaction data, and
transmitting, via the communication interface, the encrypted transaction data.

10. The user device of claim 9 wherein the one or more public key certificates comprise:
a service provider public key certificate; and
a device public key certificate.

11. The user device of claim 9 wherein the encryption algorithm comprises one or more of the following:
an RSA encryption algorithm;
a DES encryption algorithm; and
a Triple-DES encryption algorithm.

12. The user device of claim 9 wherein the decryption algorithm comprises one or more of the following:
an RSA decryption algorithm;
a DES decryption algorithm; and
a Triple-DES decryption algorithm.

13. A point of transaction terminal for ensuring secure data exchange, comprising:
a processor;
a communication interface operably connected to the processor; and
a computer-readable storage medium operably connected to the processor,
wherein the computer-readable storage medium contains one or more programming instructions for performing a method for ensuring secure data exchange, the method comprising:
receiving, via the communication interface, one or more public key certificates,
performing one or more encryption algorithms using the one or more public key certificates and one or more keys to produce an encrypted data block,
transmitting, via the communication interface, the encrypted data block,
receiving, via the communication interface, encrypted transaction data from, and
performing a decryption algorithm on the encrypted transaction data to decrypt the transaction data.

14. The point of transaction terminal of claim 13 wherein the one or more public key certificates comprise:
a service provider public key certificate; and
a device public key certificate.

15. The point of transaction terminal of claim 13 wherein performing one or more encryption algorithms comprises:
performing an encryption algorithm using the service provider public key certificate and a service provider certificate authority public key to produce a service provider public key;
performing a first encryption algorithm using the device public key certificate and the service provider public key to produce a device public key;
generating a session key; and
performing a second encryption algorithm using the session key and the device public key to produce an encrypted data block.

16. The point of transaction terminal of claim 13 wherein each of the encryption algorithms comprises one or more of the following:
an RSA encryption algorithm;
a DES encryption algorithm; and
a Triple-DES encryption algorithm.

17. The point of transaction terminal of claim 13 wherein the decryption algorithm comprises one or more of the following:
an RSA decryption algorithm;
a DES decryption algorithm; and
a Triple-DES decryption algorithm.

18. A system for securing data exchange, comprising:
a user device, wherein the user device comprises:
a device processor,
a device communication interface operably connected to the device processor, and
a device computer-readable storage medium operably connected to the device processor,
wherein the device computer-readable storage medium contains one or more programming instructions for performing a method of securing data exchange, the method comprising:
transmitting, via the device communication interface, one or more public key certificates,
receiving, via the device communication interface, an encrypted data block,
performing a decryption algorithm on the encrypted data block using a device private key to decrypt a random session key,
performing an encryption algorithm using transaction data and the random session key to produce encrypted transaction data, and
transmitting, via the device communication interface, the encrypted transaction data; and
a point of transaction terminal, wherein the point of transaction terminal comprises:
a terminal processor,
a terminal communication interface operably connected to the terminal processor and the device communication interface, and
a terminal computer-readable storage medium operably connected to the terminal processor,
wherein the terminal computer-readable storage medium contains one or more programming instructions for performing a method for ensuring secure data exchange, the method comprising:
receiving, via the terminal communication interface, one or more public key certificates,
performing one or more encryption algorithms using the one or more public key certificates and one or more keys to produce an encrypted data block,
transmitting, via the terminal communication interface, the encrypted data block,
receiving, via the terminal communication interface, encrypted transaction data from, and
performing a decryption algorithm on the encrypted transaction data to decrypt the transaction data.
